(19) United States
(12) Patent Application Publication
(10) Pub. No.: US 2011/0054854 A1
(43) Pub. Date: Mar. 3, 2011

(54) SYSTEMS AND METHODS FOR GENERATING DIMENSIONALLY ALTERED MODEL OBJECTS

(76) Inventor: Eric Williamson, Holly Springs, NC (US)

(21) Appl. No.: 12/551,330

(22) Filed: Aug. 31, 2009

(51) Int. Cl. G06F 17/10

(52) U.S. Cl. 703/2

(57) ABSTRACT

Embodiments relate to a unified management interface and related resources for generating dimensionally altered model objects. A modeling client can host modeling logic and an application programming interface (API) to create, access, manipulate, and import/export modeling objects used in modeling applications, such as engineering, medical, financial, and other modeling platforms. The source data accepted into the modeling client can include consumer or business-level applications, whose spreadsheet, database or other content can be extracted and encapsulated in object-oriented format, such as extensible markup language (XML) format. A modeling module can access the modeling objects, decode their row, column, depth, and/or other dimensional attributes, and scale those objects using scaling rules or other logic. In aspects, the dimensionally altered model object(s) can have their number of rows, columns, and/or other dimensions expanded or reduced to conform to dimensions of a destination data object, such as a spreadsheet, database, or other data structure.

### FIELD

The present teachings relate to systems and methods for generating dimensionally altered model objects, and more particularly to platforms and techniques for accessing model objects outputted by dedicated modeling of technical, medical, financial, and other systems, and expanding or reducing the row, column, or other dimension of those objects, for instance to conform the data structure of the altered version to a new data object destination.

### BACKGROUND OF RELATED ART

A spectrum of modeling platforms and options exist today for engineers, managers, developers and other professionals. In the case of engineering, medical, technical, financial, and other advanced modeling resources, a range of platforms are available for users interested in setting up, running and maintaining financial modeling systems. For example, organizations interested in relatively sophisticated modeling applications, such as geophysical models for detecting oil reserves or other geologic features or equity market analysis based on Black-Sholes option pricing models, a company or other organization may choose to install advanced modeling software on mainframe-class computers to run those classes of models and obtain various projections, reports, and other results. Such mainframe platform, data center and related installations, however, can involve costs on the order of millions of dollars or more, and may require the full time attention of highly skilled professionals, including programmers and managers with advanced training. As a consequence, putting a mainframe-based modeling operation into place may not be practical or possible for many organizations or users.

On the other end of the spectrum, managers, engineers and others may employ widely available entry-level applications to capture operational data and attempt to develop predictive models for engineering, financial, medial, and other applications. That class of applications can include, for example, consumer or business-level spreadsheet, database, or data visualization programs for technical, financial, and other purposes. For instance, a manager of a manufacturing facility may use a commercially available spreadsheet application to enter production numbers, schedules, and other details of that site. However, attempting to extract useful modeling outputs from those classes of applications can be difficult or impossible. For one, spreadsheet, database, and other widely available applications are typically built to produce reports based on already existing data, but not to generate modeling outputs or objects that represent predictive outputs or scenarios. For another, existing spreadsheet, database, and other applications typically involve limitations on cell size, number of dimensions, overall storage capacity, and other program parameters which, in the case of large-scale modeling operations, may be insufficient to operate on the data sets necessary to produce and run meaningful models.

For another, the data structures and outputs of existing spreadsheet, database and other entry-level or commonly available applications are typically arranged in proprietary format, rather than a widely interoperable object-based or other universal format. As still another drawback, the cells, rows, columns, and other data elements within commonly available spreadsheets, databases, and other entry-level programs can not be extracted as separate units and exported to other modeling or analytic tools. In further regards, besides lacking an ability to extract data objects from desired locations, available platforms do not permit a user to adjust the row, column, depth, or other dimension of a source object to match or conform to a destination data object, such as a database or spreadsheet.

In short, the use of spreadsheet, database, and other consumer or business-level applications to conduct modeling operations involves significant shortcomings, due in part to the fact that those classes of platforms are not designed to reliable handle modeling functionality. At present, therefore, a manager, developer, engineer, or other professional or user with modeling requirements is faced with a choice between installing a large and expensive mainframe-based solution with its attendant infrastructure, a spreadsheet or database-based entry level solution with its attendant limitations on power and data handling, or a combination of those two types of platforms. It may be desirable to provide object-based or object-compatible modeling platforms capable of generating a set of modeling objects which encapsulate various modeling features, and which objects can be scaled or dimensionally manipulated to ensure compatibility with target data stores.

### DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall system for a modeling network including various hardware and connectivity resources that can be used in systems and methods for generating dimensionally altered model objects, according to various embodiments of the present teachings;

FIG. 2 illustrates an exemplary modeling network including a modeling server and connectivity resources, according to various embodiments;

FIG. 3 illustrates an exemplary hardware configuration for a modeling server that can be used in systems and methods for generating dimensionally altered model objects, according to various embodiments;

FIG. 4 illustrates a flow diagram of overall modeling processing for object-based modeling that can be used in systems and methods for generating dimensionally altered model objects;

FIG. 5 illustrates exemplary operations to manipulate sets of modeling objects to generate one or more dimensionally altered model object, according to various embodiments; and

FIG. 6 illustrates a flow diagram of processing to generate dimensionally altered model objects, according to various embodiments.

### DESCRIPTION OF EMBODIMENTS

Embodiments of the present teachings relate to systems and methods for generating dimensionally altered model objects. More particularly, embodiments relate to platforms and techniques that can access, extract, and generate modeling objects in a native object-based or object-compatible format. The modeling objects produced via a modeling client or other modeling tool according to the present teachings can encapsulate both source data describing a physical, medical, technical, financial, or other process or phenomena, and modeling attributes that relate the source data to predictive scenarios, specific models, and other features. In embodiments, the modeling objects can be extracted or “lifted” from data sources such as database programs or others, and stored to local storage of a local modeling client.

The resulting set or sets of model objects can be accessed and manipulated by a modeling module or other logic in the modeling client to scale, resize, or otherwise alter the dimensions and/or related attributes of one or more of those objects. In aspects, data from the model object(s) can be expanded or, generally speaking, “stretched” in its dimensions, for instance to create or add additional rows, columns, depth planes, and/or other dimensions. The expanded dimensions can, in embodiments, involve the copying of data into duplicate cells or patterns of cells. In aspects, data from the model object(s) can be reduced or, generally speaking, “compressed” in its dimensions, for instance to reduce the number rows, columns, depth planes, and/or other dimensions. The reduced dimensions can, for instance, be generated or determined by combining data from different cells or entries, deleting cells or entries, or performing other operations on the constituent data content to make the number of rows, columns, depth planes, and/or other dimensions or associated attributes smaller.

According to aspects, the set of dimensionally altered model objects can be stored to a new or destination database, spreadsheet, data store, and/or other data object or data schema. In embodiments, the dimensionally altered data object(s) can have their dimensions scaled up or down to conform to the data schema of the destination data object, for example, to fit into a relational database or other structure. It may be noted that in embodiments, the modeling module can leave or retain the original or source data in the source object or other location, in its pre-altered state. In aspects, each dimensionally altered data object can be duplicated, inserted, and/or stored to a destination multiple times, for example to different entries in a database, or to different databases or other destinations These and other embodiments described herein address the various noted shortcomings in known modeling technology, and provide a user or operator with enhanced modeling power on a desktop or other client, allowing the flexible configuration and scaling of model objects to insert and store model objects into desired data object containers, formats, and/or other destinations. Systems and methods according to the present teachings also allow seamless generation, local storage, and communication of model objects and their interconnections to backend mainframe platforms, data centers, middleware servers, other modeling clients, and/or other local or remote modeling, storage, or data processing resources.

Reference will now be made in detail to exemplary embodiments of the present teachings, which are illustrated in the accompanying drawings. Where possible the same reference numbers will be used throughout the drawings to refer to the same or like parts.

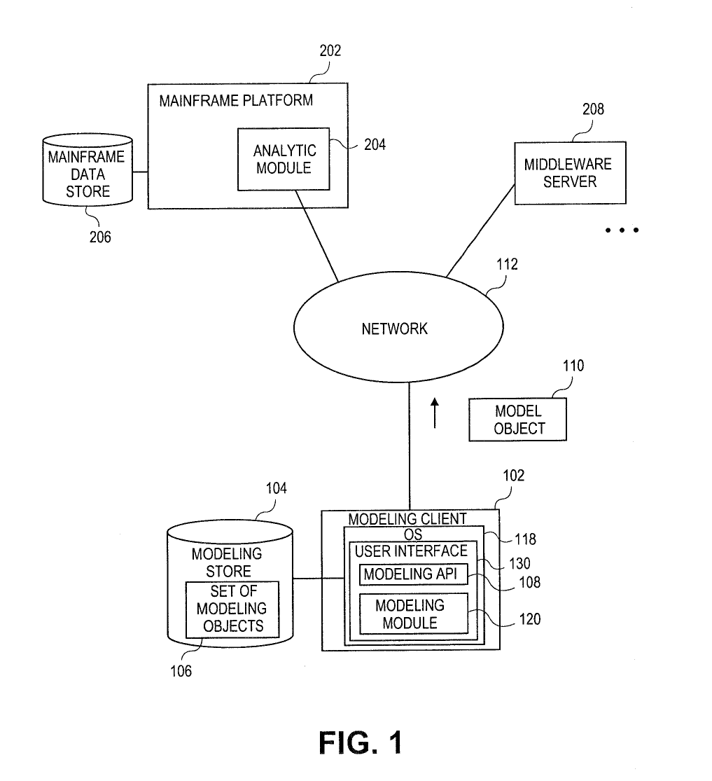

FIG. 1 illustrates an overall network 100 in which systems and methods for generating dimensionally altered model objects, consistent with various embodiments of the present teachings. In embodiments as shown, a modeling client 102 can communicate with a variety of local and remote resources, including an mainframe platform 102 via one or more network 112. Client 102 can be or include, for instance, a personal computer, a server, a dedicated workstation, a mobile device, or other machine, device, hardware, or resource. One or more network 112 can be or include, for example, the Internet, a virtual private network (VPN), a local area network such as an Ethernet™ network, or other public or private network or networks. Mainframe platform 102 can be or include commercially available platforms or installations, such as, merely for example, mainframe or enterprise platforms available from SAP Inc. of Walldorf, Germany, and other sources.

Mainframe platform 102 can include modules, logic, and functionality to perform an array of computation and data storage tasks, including data warehousing, data mining, statistical analyses, financial planning, inventory management, customer resource management, engineering design, and other applications. In implementations as shown, mainframe platform 102 can host or communicate with a variety or resources including, merely illustratively, a mainframe data store 206, and logic or applications including an analytic module 204. Mainframe platform 102 can contain, host, support, or interface to other data processing hardware, software, and other resources. In embodiments, modeling client 102 can likewise communicate with other local or remote resources, such as a middleware server 208 hosting or interfacing to a set of data stores for online analytical processing (OLAP) or other functions. Modeling client 102 can also communicate or interface with other local or remote servers, services, data stores, or other resources.

In embodiments as shown, modeling client 102 can operate under an operating system 118, such as a distribution of the Linux™, Unix™, or other open source or proprietary operating system. Modeling client 102 can present a user interface 130, such as a graphical user interface or command line interface, operating under operating system 118 to receive commands and inputs from a user, and operate modeling client 102. Modeling client 102 can communicate with storage resources including a modeling store 104, such as a local or remote database or data store. Modeling store 104 can store a set of modeling objects 106, in which data, functions, procedures, attributes, and/or other information related to one or more modeling object 110 can be encapsulated and stored. In embodiments, modeling object 110 can be encoded in extensible markup language (XML) format. In embodiments, modeling object 110 can be encoded in other object-based or object-compatible formats or data structures. Modeling client 102 can communicate with mainframe platform 102 via a modeling application programming interface (API) 108. Modeling application programming interface (API) 108 can include, for instance, defined function calls or calls to other routines, calculations, or features, as well as data structures and parameters associated with modeling operations. For example, modeling application programming interface (API) 108 can include a function call to invoke a Monte Carlo simulation model based on a set of supplied data, such as an identified set of dimensions extracted from a spreadsheet or database. Other functions, routines, resources, and features can be called, invoked, or instantiated via modeling application programming interface (API) 108. According to embodiments in various regards, one or more local or remote modeling packages, modules, or other supporting applications can be instantiated via modeling module 120 and modeling application programming interface (API) 108 to manipulate source data and resulting one or more modeling object 110.

In embodiments, a user of modeling client 102 can access, modify, or add data modeling objects to a set of data modeling object 106 via a modeling module 120 hosted in modeling client 102. Set of data modeling objects 106 can include data objects that the user of modeling client 102 has directly entered, or, in aspects, which the user of modeling client has imported or extracted from sources such as consumer or business-level spreadsheet, database, and/or other applications or platforms. Modeling module 120 can itself be or include applications, software modules or hardware modules, or other logic or resources to operate on set of modeling objects 106. Modeling module 120 can, merely illustratively, include or access logic or modules for invoking and manipulating a variety of scientific, technical, engineering, medical, financial, manufacturing, or other modeling operations. For instance, modeling module 120 can be or include applications or logic for performing Monte Carlo simulations, finite element analyses, Black-Scholes option pricing or other market analyses, epidemiological projections, geophysical models or simulations, or other simulations, models, trend mappings, projections, or other predictive processes. In embodiments in one regard, after invoking modeling module 120 and performing any modeling task, the user of modeling client 102 can locally store and/or export one or more modeling object 110 to external platforms or resources.

In embodiments as shown, the user of modeling client 102 can for instance export or communicate one or more modeling object 110 to mainframe platform 102 via modeling application programming interface (API) 108, for storage and use at a local or remote location from within that platform. In aspects, mainframe platform 102 can receive modeling object 110 directly without a necessity for translation, re-formatting, or invoking any spreadsheet, database, or other application from which data encapsulated in one or mode modeling object 110 originated. In aspects, mainframe platform 102 can operate on one or more modeling object 110, and transmit or return that data or other results to modeling client 102 via modeling application programming interface (API) 108. Thus, according to aspects of the present teachings, modeling objects can be exchanged directly and programmatically between modeling client 102, mainframe platform 102 or other larger-scale or remote platforms, including for instance middleware server 208 or other comparatively large-scale or higher-capacity modeling or analytic tools.

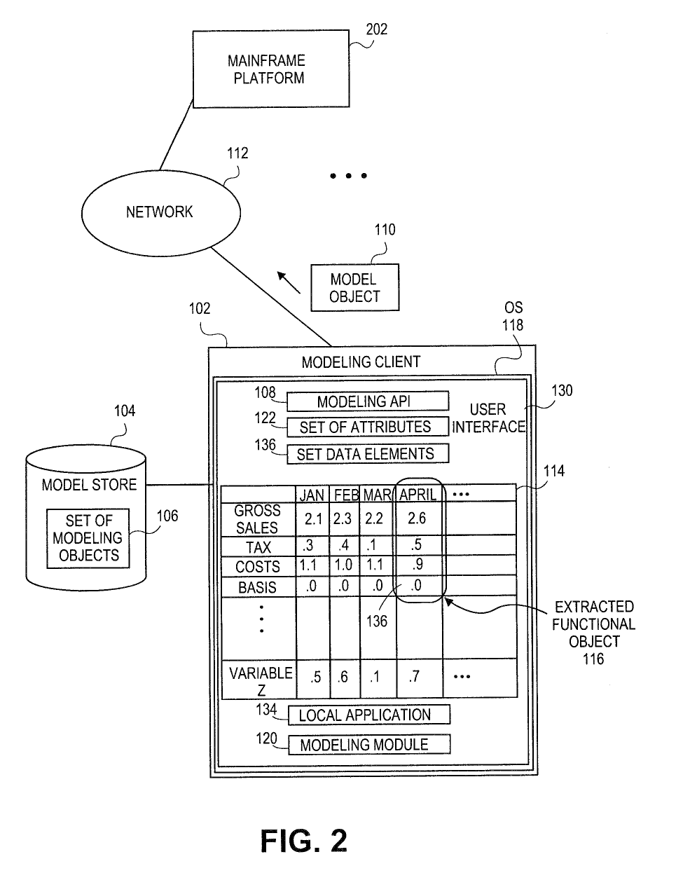

In terms of operating on source data and generating one or more modeling object 110 for local storage and/or exchange with mainframe platform 102 or other platforms, and as shown for instance in FIG. 2, according to various embodiments, a user of modeling client 102 can invoke modeling module 120 to manipulate a set of source data 114 to identify, configure, and/or extract the functional objects, attributes, or other features of a set of data to produce a modeling output. In embodiments as shown, modeling module 120 can access a set of source data 114, from which data, attributes, and/or other metadata can be extracted to generate one or more modeling object 110. In aspects, set of source data 114 can be generated, hosted, or stored by or in a local application 134, such as a spreadsheet, database, accounting, word processing, presentation, or other application or software. In aspects, set of source data 114 can comprise data previously or newly generated in the form of an object-based modeling object, such as a modeling object entered, imported, or specified by the user of modeling client 102. In aspects, set of source data 114 can comprise data originally stored or generated in a consumer or business-level spreadsheet, database, and/or other application or software. In aspects, set of source data 114 can be initially formatted or encoded in a non-object oriented format, such as in a cellular array or in a relational database format. In aspects, set of source data 114 can be initially formatted or encoded in an object-oriented format, such as extensible markup language (XML) format. In aspects, a user of modeling client 102 can highlight, select, or otherwise specify all or a portion of set of source data 114 to generate one or more extracted functional object 116. For instance, a user can highlight a column of set of source data 114 to identify and extract data as well as functional relationships of interest, to the user, as a unified object. Thus, purely illustratively and as shown, a user may wish to obtain a view on a current month's sales figures including gross sales, tax, production or delivery costs, and cost basis, as well as other parameters related to sales activity. In aspects as shown, a user can, for instance, highlight those functional relationships by dragging a cursor or otherwise selecting a set of cells to group together, and form one or more extracted functional object 116. In aspects, selection can include the extraction of set of data elements 136, such as values stored in spreadsheet cells or database entries. In aspects, once a set of data elements 136 are selected, the functional, computational, or other modeling parameters associated with that data cane be stored or associated with one or more extracted functional object 116. For instance, modeling module 120 can store associated routines, computations, processes, or other attributes or functional specifications for one or more extracted functional object 116 in set of attributes 122, which can be stored or associated with one or more extracted functional object 116. In aspects, set of attributes 122 can include the identification of or linkage to any routines, interfaces, or other functional or computational resources that will be associated with one or more extracted functional object. According to various embodiments, analytic module 204 of mainframe platform 102, or other resource or platform receiving one or more extracted functional object 116 from modeling client 102 can thereby obtain both data values derived or obtained from set of source data 114, as well as functional or procedural resources and relationships associated with that data. One or more extracted functional object 116 along with any associated set of attributes 122 can be encoded or stored in one or more modeling object 110, which can thereby be transparently exported to mainframe platform 102, middleware server 208, or other platforms or destinations for further modeling operations.

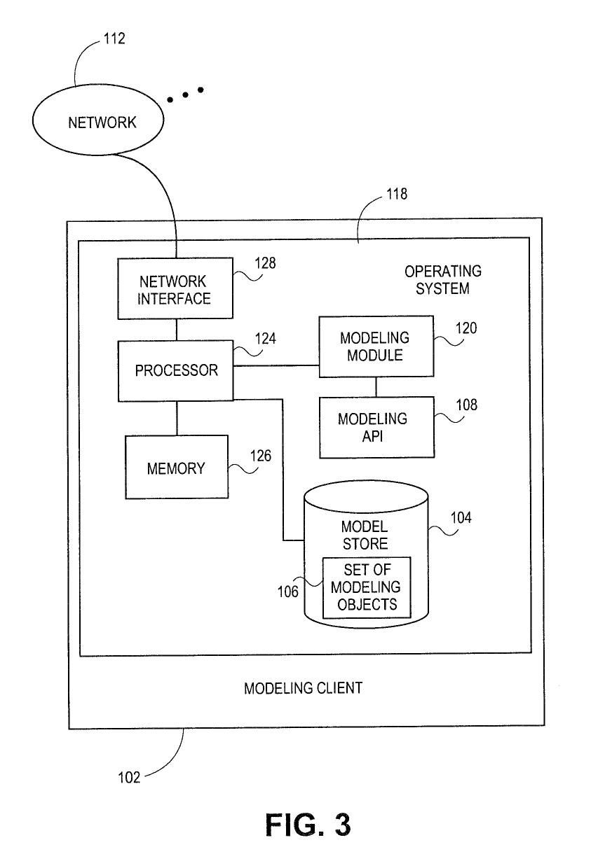

FIG. 3 illustrates an exemplary diagram of hardware, software, connectivity, and other resources that can be incorporated in a modeling client 102 configured to communicate with one or more network 112, including to interface with mainframe platform 102, middleware server 208, and/or other local or remote resources. In embodiments as shown, modeling client 102 can comprise a processor 124 communicating with memory 126, such as electronic random access memory, operating under control of or in conjunction with operating system 118. Operating system 118 can be, for example, a distribution of the Linux™ operating system, the Unix™ operating system, or other open-source or proprietary operating system or platform. Processor 124 also communicates with a model store 104, such as a database stored on a local hard drive, which may store or host set of modeling objects 106. Processor 124 further communicates with network interface 128, such as an Ethernet or wireless data connection, which in turn communicates with one or more networks 112, such as the Internet, or other public or private networks. Processor 124 also communicates with modeling module 120 along with modeling application programming interface (API) 108 and/or other resources or logic, to execute control and perform modeling calculation, translation, data exchange, and other processes described herein. Other configurations of the network modeling client 102, associated network connections, and other hardware and software resources are possible. While FIG. 3 illustrates modeling client 102 as a standalone system comprises a combination of hardware and software, modeling client 102 can also be implemented as a software application or program capable of being executed by a conventional computer platform. Likewise, modeling client 102 can also be implemented as a software module or program module capable of being incorporated in other software applications and programs. In either case, modeling client 102 can be implemented in any type of conventional proprietary or open-source computer language.

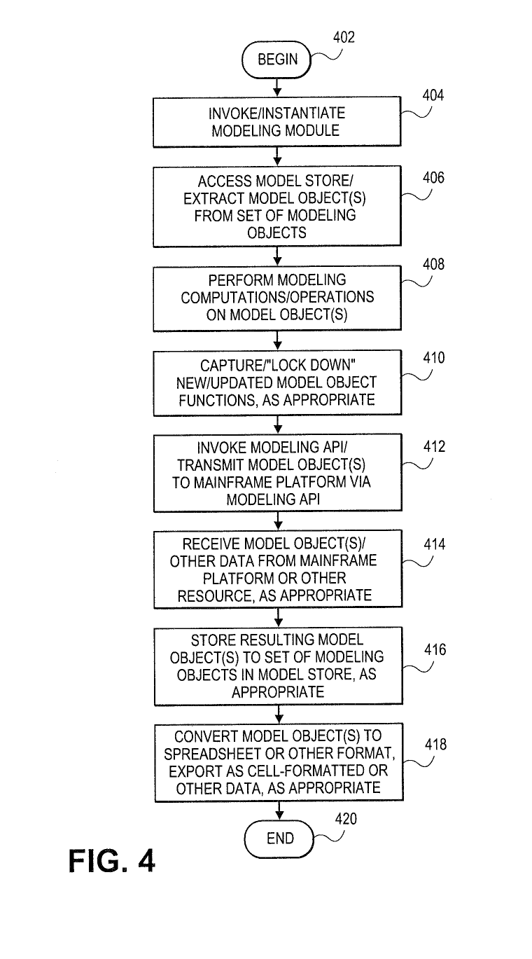

FIG. 4 illustrates a flow diagram of overall processing that can be used in general in systems and methods for generating dimensionally altered model objects. In 402, processing can begin. In 404, a user of modeling client 102 or other client or device can invoke or instantiate modeling module 120 or other logic, to perform modeling operations. In 406, modeling module 120 can access model store 104 and extract one or more modeling object 110 from set of modeling objects 106. In 408, modeling computations or other operations can be performed on one or more modeling object 110. For example, a modeling operation can be performed to project or predict the output of a factory based on various supply scenarios for parts, materials, energy costs, or other variables. In 410, the values, functions, linkages, or other attributes of one or more data modeling object 110 that were accessed, produced, or modified by the modeling operations can be captured, fixed, or locked down by modeling module 120. For instance, the resulting one or more modeling object 110 can be stored to set of modeling objects 106 in model store 104, or other databases or data stores.

In 412, modeling application programming interface (API) 108 can be invoked by modeling module 120, by mainframe platform 102, or other resources to transfer one or mode modeling object 110 to mainframe platform 102. In embodiments, one or more modeling object 110 can for instance be communicated to mainframe platform 102 via a secure connection or channel, such as a secure socket layer (SSL) connection, via a channel encrypted using a public/private key infrastructure, or other channel or connection. In 414, one or more model object 110 can be received in modeling module 120 from mainframe platform 102 or other resource, as appropriate. For example, an updated version of one or more model object 110 reflecting new data, new modeling results, or other information can be received in modeling module 120. In 416, the resulting new, updated, or modified one or more model object 110 can be stored to set of modeling objects 106 in model store 104, as appropriate. In embodiments, one or more model objects 110 can in addition or instead be stored to mainframe data store 206, to middleware server 208, to another modeling client or other client, or other site or destination. In 418, modeling module 120 can convert one or more model objects 110 to spreadsheet, database, or other format, and export any converted data as a set of cell-formatted information, or data encoded in other formats. For instance, modeling module 120 can convert or translate one or more model objects to cell data values or database entries, and export that data to client-level applications on modeling client 102 or other local or remote devices or storage. In 420, processing can repeat, return to a prior processing point, jump to a further processing point, or end.

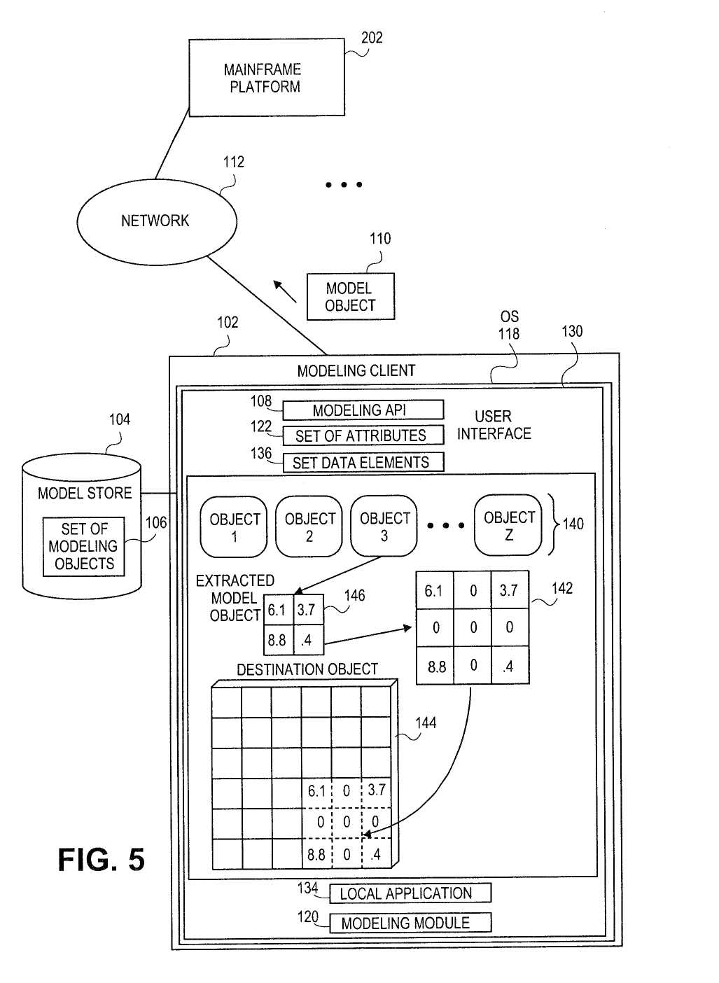

According to various embodiments of the present teachings, and as for example generally illustrated in FIG. 5, in implementations modeling module 120 can generate and/or access a set of modeling objects, for instance using techniques described herein, which objects can be accessed, manipulated, and configured in terms of scaling or other dimensional adjustments. More particularly, in aspects as shown, a set of model objects 140 can be generated and/or accessed via modeling client 102 hosting or accessing a modeling module 120 and associated resources. In aspects, each object in set of model objects 140 can be or include an object similar to model object 110 described herein.

In aspects, as noted modeling module 120 can a perform configuration and management of set of model objects 140 In aspects, modeling module 120 can comprise a module, logic, or layer that is separate from, or can be integrated with, operating system 118 of modeling client 102. According to aspects in various regards, modeling module 120 can permit a user to highlight, click, select by radio button or link, or otherwise select or identify one or more objects in set of model objects 140 upon which re-sizing or other actions to alter the dimensional attributes of one or more model objects may be taken.

In aspects as shown, an extracted model object 146 that is highlighted or otherwise selected from set of model objects 140 can be operated on by modeling module 120 to generate a scaled model object 142. In embodiments as shown, the original extracted model object 146 can have a set of dimensional attributes and/or values, such as, for instance, a row by column size of 2×2, such as in a matrix, database entry, spreadsheet cell, or other data format. In embodiments as likewise shown, the modeling module 120 can determine the original dimensional attributes of extracted model object 146, and expand those dimensions to generate additional row values, column values, depth plane values, and/or other attributes or features. For instance, modeling module can generate a scaled model object having a row by column size of 36×36, in which the smaller 2×2 sized object is replicated around the center block of the extracted model object 146. In aspects, modeling module 120 can, as shown, place the original data values from the entries or cells of the 2×2 object into the corners of scaled model object 142, preserving the corner values of the originating object in corresponding corners of the expanded object. In embodiments, other techniques for translation or importation of data values to scaled model object 142 can be used. For instance, the cells of extracted model object 146 can be filled with multiple copies of the data values hosted in extracted model object 146, or, in embodiments, the cells or other nodes of scaled model object 142 can be filled with zero or other default values. In aspects, scaled model object 142 can be scaled to greater than three dimensions. In aspects, it may be noted that in addition to expanding the dimensions of scaled model object 142, the dimensions of extracted model object 146 can be reduced, for instance, to eliminate or or more rows and/or columns. Other types of dimensional alterations can be performed on extracted model object 146 to generate scaled model object 142.

In embodiments, it may be noted that scaled model object 142 can be stored, copied, and/or otherwise inserted into destination model object 144. In aspects, scaled model object 142 can be scaled by modeling module 130 to conform to the dimensions or other configuration requirements of destination model object 144, such as, for example, to conform the number of rows and columns of scaled model object 142 to those of destination model object 144. Other types of conforming, fitting, or other scaling relationships between extracted model object 146 and destination model object 144 can be used. It may be likewise noted that in aspects, scaled model object 142 can be stored, hosted, or otherwise communicated or inserted to multiple destination objects, such as other local or remote databases, spreadsheets, and/or other data objects or stores.

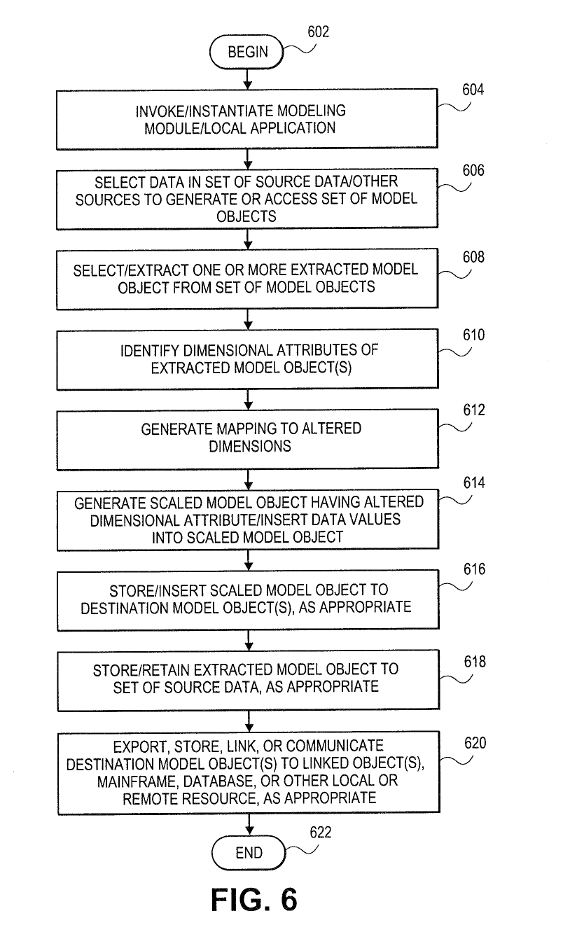

FIG. 6 illustrates a flow diagram of overall processing to organize, configure and scale or otherwise manipulate the dimensions of set of modeling objects 140, according to various embodiments. In 602, processing can begin. In 604, a user can invoke or initiate modeling module 120 and/or local application 136, such as, for instance, a spreadsheet application, a database application, or other applications or software. In 606, the user can select data in set of source data 114 or other data sources to generate a set of model objects 140, each of which can be, include, or be generally similar to model object 110 as described herein, including related data elements and attributes. In 608, one or more extracted model object 146 can be selected and/or extracted from set of model objects 140, for instance by user selection. In 610, modeling module 120 or other logic can identify the dimensional attributes of the one or more extracted model object 146. For instance, the existence of one, two, three or more dimensions in extracted model object 146, and/or the extent or size of the object in each of those dimensions (e.g., 4 columns by 2 rows), can be identified. In 612, modeling module 120 or other logic can generate a mapping between the dimensions of extracted model object 146 and a desired altered set of dimensions and related attributes to be used in scaled model object 142. In 614, modeling module 120 or other logic can generate scaled model object 142 having modified dimensional attributes, and in embodiments data values can be inserted into scaled model object 142, for instance to store null values, duplicate values, repeated values, or other values into cells or other locations of scaled model object 142. In 616, modeling module 120 or other logic can store or insert scaled model object 142 into one or more destination model object 142, as appropriate. In 618, modeling module 120 or other logic can store or retain the one or more extracted model object 146 in the original set of source data, as appropriate. In embodiments, extraction of extracted model object 146 can automatically leave the original data structure and values intact in the source object. In 620, destination model object 142 and/or one or more individual scaled model object 142 can be exported, stored, linked, and/or communicated to other linked objects, applications, set of platforms 210 such as mainframe resources, middleware servers, databases, and/or other local or remote services or resources. In 622, processing can repeat, return to a prior processing point, jump to a further processing point, or end.

The foregoing description is illustrative, and variations in configuration and implementation may occur to persons skilled in the art. For example, while embodiments have been described wherein one or more model object 110 is accessed and manipulated via one modeling client 102, in embodiments, one or more users can use multiple modeling clients, or networks including modeling clients or other resources, to operate on model object data. For further example, while embodiments have been described in which modeling client 102 may interact with one mainframe platform 102 and/or one middleware server 208, in embodiments, one or more modeling client 102 can interact with multiple mainframe platforms, data centers, middleware servers, and/or other resources, in various combinations. Yet further, while embodiments have been described in which a modeling client 102 interacts with a mainframe platform 102 and/or middleware server 208, in embodiments, rather than interact with large-scale mainframe platforms, data centers, or middleware servers, modeling client 102 can interact with other local or remote modeling clients, networks of those clients, or, in embodiments, can operate to perform modeling operations on a stand-alone basis, without necessarily communicating with other modeling platforms. Still further, while embodiments have been described in which one or more scaled model object 142 is stored to one destination model object 144, in embodiments, scaled model object 142 can be stored or copies to multiple targets or destinations. Other resources described as singular or integrated can in embodiments be plural or distributed, and resources described as multiple or distributed can in embodiments be combined. The scope of the present teachings is accordingly intended to be limited only by the following claims.

What is claimed is:

1. A method of reproducing a model object, comprising:
accessing a set of source data;
accessing a set of model objects from the set of source data, each model object in the set of model objects being based on at least one extracted data element and at least one attribute of the extracted data element,
extracting at least one model object from the set of model objects;
generating a dimensionally altered version of the at least one extracted model object having an expanded or reduced set of dimensions; and
storing the dimensionally altered version of the at least one one extracted model object to a set of destination data.

2. The method of claim 1, wherein the dimensionally altered version of the at least one extracted model object comprises a model object having at least one of a set of rows and a set of columns scaled up or down to conform to a dimensional size of the set of destination data.

3. The method of claim 2, wherein the scaling up or down of the at least one extracted model object comprises a scaling up of the at least one extracted model object, and the scaling up comprises a duplication of the at least one extracted model object an integer number of times in at least one dimension.

4. The method of claim 3, wherein the scaling up further comprises generating a set of duplicate layers of the at least one extracted model object along a depth dimension.

5. The method of claim 1, wherein the at least one extracted model object is retained in the set of source data.

6. The method of claim 1, wherein the set of managed model objects comprises at least one model object encoded in extensible markup language (XML) format.

7. The method of claim 1, wherein at least one of the set of source data and the set of destination data comprises at least one of spreadsheet data, database data, word processing data, or presentation data.

8. The method of claim 1, wherein the at least one dimensionally altered model object is stored to the set of source data.

9. The method of claim 1, wherein dimensionally altered version of the at least one one extracted model object is stored a plurality of times to one or more sets of destination data.

10. A client system, comprising:
an interface to a set of model objects generated from a set of source data, each model object in the set of model objects being based on at least one extracted data element and at least one attribute of the extracted data element; and
a processor, communicating with the set of source data via the interface, the processor being configured to
extract at least one model object from the set of model objects,
generate a dimensionally altered version of the at least one extracted model object having an expanded or reduced set of dimensions, and
store the dimensionally altered version of the at least one one extracted model object to a set of destination data.

11. The system of claim 10, wherein the dimensionally altered version of the at least one extracted model object comprises a model object having at least one of a set of rows and a set of columns scaled up or down to conform to a dimensional size of the set of destination data.

12. The system of claim 11, wherein the scaling up or down of the at least one extracted model object comprises a scaling up of the at least one extracted model object, and the scaling up comprises a duplication of the at least one extracted model object an integer number of times in at least one dimension.

13. The system of claim 12, wherein the scaling up further comprises generating a set of duplicate layers of the at least one extracted model object along a depth dimension.

14. The system of claim 10, wherein the at least one extracted model object is retained in the set of source data.

15. The system of claim 10, wherein the set of managed model objects comprises at least one model object encoded in extensible markup language (XML) format.

16. The system of claim 10, wherein at least one of the set of source data and the set of destination data comprises at least one of spreadsheet data, database data, word processing data, or presentation data.

17. The system of claim 10, wherein the at least one dimensionally altered model object is stored to the set of source data.

18. The system of claim 10, wherein dimensionally altered version of the at least one one extracted model object is stored a plurality of times to one or more sets of destination data.

19. A set of model object data stored in a computer readable medium, comprising:
a set of model objects; and
at least one dimensionally altered model object, the dimensionally altered model object
being based on at least one extracted model object based on at least one data element and at least one attribute of the extracted data element extracted from a set of source data, and
having an expanded or reduced set of dimensions from the at least one extracted model object.

20. The set of model object data of claim 19, wherein the dimensionally altered version of the at least one extracted model object comprises a model object having at least one of a set of rows and a set of columns scaled up or down to conform to a dimensional size of the set of destination data.
